(19) United States
(12) Patent Application Publication
(10) Pub. No.: US 2005/0015474 A1
(43) Pub. Date: Jan. 20, 2005

(54) Extensible customizable structured and managed client data storage

(76) Inventors: Sathyanarayanan N. Kavacheri, Sunnyvale, CA (US); Wun-Mai Jennifer Chang, San Jose, CA (US); Luu D. Tran, Santa Clara, CA (US); Veiming Seah, San Jose, CA (US)

Correspondence Address: OSHA & MAY L.L.P./SUN, 1221 MCKINNEY, SUITE 2800, HOUSTON, TX, 77010, US

(21) Appl. No.: 10/622,158

(22) Filed: Jul. 16, 2003

(51) Int. Cl. G06F 15/173; G06F 15/00

(52) U.S. Cl. 709/223; 715/513

(57) ABSTRACT

Methods and systems thereof for storing, reading and writing wireless client device profiles are described. A node is created for each device and the properties of the client devices are stored as attributes of a respective node. By storing the profiles in this manner, the reading of a device property reduces to fetching an attribute of the appropriate node, and the writing of a device property is reduced to modifying an attribute of the appropriate node. Parsing and validation of device profiles are eliminated, improving performance. Moreover, the profiles are managed by a user-friendly interface.

### RELATED UNITED STATES PATENT APPLICATIONS

This Application is related to U.S. patent application Ser. No. ______ by G. Ziebold et al., filed on Jul. 16, 2003, entitled “System and Method for Client Aware Request Dispatching,” with Attorney Docket No. SUN-PO30066, and assigned to the assignee of the present invention.

This Application is related to U.S. patent application Ser. No. ______ by S. Kavacheri et al., filed on Jul. 16, 2003, entitled “Hierarchical Client Detection in a Wireless Portal Server,” with Attorney Docket No. SUN-PO30067, and assigned to the assignee of the present invention.

This Application is related to U.S. patent application Ser. No. ______ by G. Ziebold et al., filed on Jul. 16, 2003, entitled “Hierarchical Client Aware Content Aggregation in a Wireless Portal Server,” with Attorney Docket No. SUN-PO30068, and assigned to the assignee of the present invention.

### BACKGROUND OF THE INVENTION

1. Field of the Invention

Embodiments of the present invention generally pertain to portal servers. More specifically, embodiments of the present invention pertain to computer-implemented methods for storing and retrieving device-dependent properties used by a portal server.

2. Related Art

A portal server, generally speaking, is a specialized sort of Web server. A portal server utilizes software that manages user access to Web applications and services that are available over the Internet as well as over corporate intranets. A typical Web page is relatively anonymous, providing generalized content that is the same for all users. A portal is more personalized than a typical Web page, providing a Web page customized to a user or group of users. A portal can also provide services such as electronic mail (e-mail), calendar, and address book services.

A shortcoming of conventional Web servers as well as portal servers arises from the overwhelming diversity in the types of client devices that can be used to access Web applications and services. Initially, Web applications and services were accessed using a personal computer that was running a Web browser. Though there was some diversity in types of personal computers, the vast majority of personal computers (PCs) used one of a small number of operating systems, and were equipped with a full-sized display monitor and large memories. Similarly, although there was some diversity in browsers, browsers generally used HyperText Markup Language (HTML). Consequently, Web pages could be designed using HTML for execution on a resource-rich, PC using some type of popular operating system, with a reasonable expectation that the Web pages could be used by just about everyone.

However, this paradigm is being challenged because of the profusion of mobile (e.g., wireless) client devices such as cell phones and personal digital assistants (PDAs) that now have the capability to access the Web. These devices have processing and memory capabilities that rival early computers, but remain limited in comparison to contemporary PCs. Thus, while mobile client devices can access the Web, they do not necessarily have the capacity to use a Web page designed for a more powerful computer system. Also, as mentioned above, a Web page is typically designed for use on a full-size monitor. In comparison, the displays used by mobile client devices are much smaller and provide less resolution. As such, a Web page designed for a PC may not be legible on a mobile client device, or only a small portion of the Web page may be displayed at a time.

Furthermore, mobile client devices typically do not use HTML, relying instead on different markup languages such as Wireless Markup Language (WML). As a consequence, a Web page written using HTML may not be decipherable on a mobile client device.

A Web server, in particular a portal server, that can provide content, in particular Web-based content, to mobile client devices and other types of limited-resource devices would be of value. However, there are possibly tens of thousands of different types of mobile client devices in use, and the number is growing. Associated with each of these devices is a device profile that identifies the characteristics and properties of the device. The device profile identifies properties such as screen size, keyboard capability, memory capacity, etc. There may be up to 200 characteristics and properties associated with each device profile.

Composite Capabilities/Preferences Profiles (CC/PP) and User Access Profiles (UAProf) provide frameworks for describing and managing device profiles. These frameworks provide a way to describe device profiles that are accessible from some type of centralized source (e.g., from a directory server coupled to a portal server), so that the profiles do not need to be sent to the portal server by the mobile client devices themselves.

The device profiles are defined in the form of an Extensible Markup Language (XML) file for each device. These files can be relatively large, and storing all of them on a directory server can consume a lot of memory because of the large number of different types of client devices that are in use. In addition, reading and modifying the XML files is difficult and expensive from a resource utilization point of view. For example, to modify a property in an XML file, the full document is read, parsed, modified, converted to a string, and written back to storage. This can consume a lot of processor cycles and memory.

### SUMMARY OF THE INVENTION

Accordingly, a method and/or system that allows device profiles to be more efficiently stored, read and modified would be advantageous. Embodiments of the present invention provide these advantages.

Methods and systems thereof for storing, reading and writing wireless client device profiles are described. According to one embodiment of the present invention, information that identifies properties of each of a plurality of wireless client devices is received. The information is received in Extensible Markup Language (XML) form. A node in a software directory is created for each of the wireless client devices. The information that identifies the properties of each wireless client device is stored as attributes of a respective node in the software directory. The information for each of the wireless client devices is stored in other than an XML form.

In a particular embodiment, a Lightweight Directory Access Protocol (LDAP) subschema element is defined for each device. The subschema creates an LDAP Directory Information Tree (DIT) for each device. The client properties are stored as an instance of the subschema. Accordingly, properties of devices can be grouped without having to use XML.

In summary, embodiments of the present invention allow device-dependent characteristics and properties to be readily stored and retrieved on a server such as a portal server or on a directory server in communication with a portal server. A node is created for each device and properties of the device are attributes of the node. By storing device profiles in this manner, the reading of a device property reduces to fetching an attribute of the appropriate node, and the writing of a device property reduces to modifying an attribute of the appropriate node. Parsing and validation of device profiles can be eliminated, improving performance. Moreover, the profiles can be managed by a user-friendly interface. As a result, the portal server can quickly and efficiently provide services and other types of support for a wide variety of client devices having different properties.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of a hardware architecture for an exemplary computer system upon which embodiments of the present invention can be implemented.

FIG. 2 is a block diagram showing the elements of a software architecture implemented on a portal server according to one embodiment of the present invention.

FIG. 3 is a block diagram of an exemplary network including a portal server and directory server according to one embodiment of the present invention.

FIG. 4 is a flowchart of one embodiment of a computer-implemented process for storing device profiles according to an embodiment of the present invention.

FIG. 5 is a block diagram showing data flow through a portal server and a directory server according to an embodiment of the present invention.

### DETAILED DESCRIPTION OF THE INVENTION

Reference will now be made in detail to the various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

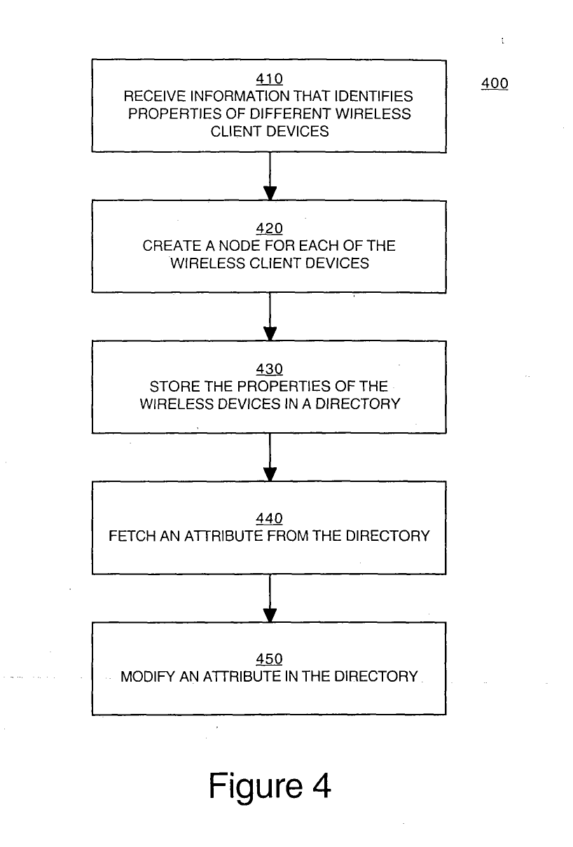

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing,” “creating,” “receiving,” “parsing,” “fetching,” “modifying” or the like, refer to the action and processes (e.g., flowchart 400 of FIG. 4) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

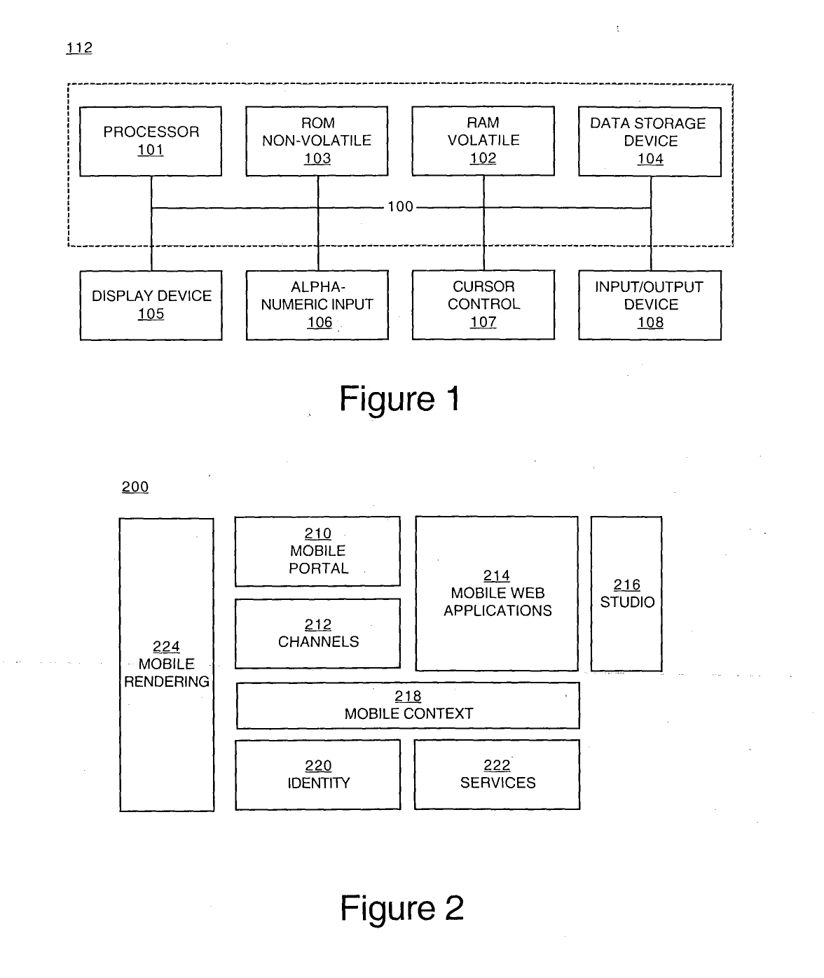

FIG. 1 is a block diagram of an exemplary computer system 112 (e.g., a portal server system or identity server system) upon which embodiments of the present invention can be implemented. It is appreciated that computer system 112 described herein illustrates an exemplary configuration of an operational platform. Nevertheless, other computer systems with differing configurations can also be used in place of computer system 112 within the scope of the present invention.

Computer system 112 includes an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, EPROM, EEPROM, etc.) coupled with bus 100 for storing static information and instructions for processor 101. Computer system 112 can also contain an optional display device 105 coupled to bus 100 for displaying information to the computer user. Moreover, computer system 112 also includes a data storage device 104 (e.g., disk drive) for storing information and instructions.

Also included in computer system 112 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface (input/output device) 108, which is also coupled to bus 100. Communication interface 108 can also include wireless communication mechanisms.

FIG. 2 is a block diagram showing the elements of a software architecture 200 implemented on a portal server according to one embodiment of the present invention. A portal server may also be implemented using an identity server.

Portal servers conventionally enable personal computers (PCs) to access content. Architecture 200 is used by a portal server to provide content to a variety of different types of devices that have limited capabilities and features in comparison to conventional PCs, or that have characteristics and properties different than a PC. For example, a mobile device might use Wireless Markup Language (WML) rather than HyperText Markup Language (HTML). More specifically, architecture 200 enables mobile access to content provided by a portal server. Architecture 200 can be implemented on a portal server on top of existing software, allowing the portal server to service PCs as well as mobile devices such as cell phones and personal digital assistants (PDAs).

In the present embodiment, architecture 200 includes the following blocks: mobile portal 210, channels 212, mobile Web applications 214, studio 216, mobile context block 218, identity block 220, services block 222, and mobile rendering block 224. It is appreciated that architecture 200 can include elements in addition to those shown, and can also include other elements not shown or described herein. Furthermore, the blocks shown by FIG. 2 can implement additional functions not described herein.

A user first interacts with a portal server via mobile portal 210, which provides a summary of the services available to the user and which also provides links to the various Web applications. Identity block 220 is for storing persistent data such as credentials utilized for authentication of the user. Identity block 220 can be implemented on the portal server or on another server known as an identity server.

Each of the channels 212 represents an aggregation of different services (e.g., services 222). Services in services block 222 are exemplified by applications such as electronic mail (e-mail), address book, and calendar applications. Mobile Web applications 214 represent applications that can be used by mobile client devices. Studio 216 allows the development of Web applications and channels that can be used in the mobile environment.

Mobile rendering block 224 identifies the type of client device that is accessing the portal server, and the characteristics and properties of that device. These characteristics include but are not limited to screen size, buffer size, and markup language used. Once the type of device is known, content can be formatted for the device. Mobile context block 218 can identify content that is independent of the type of client device and content that depends on the type of client device. For device-dependent content, mobile context block 218 sets up an environment that is correct for the type of client device that is accessing the portal server.

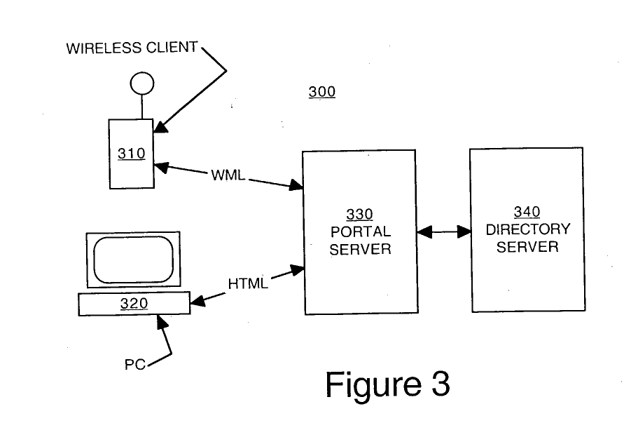

FIG. 3 is a block diagram of an exemplary network 300 according to one embodiment of the present invention. In the present embodiment, network 300 includes a portal server 330 and a directory server 340. It is appreciated that the functionality provided by portal server 330 and directory server 340 can alternatively be integrated into a single server.

Client devices 310 and 320 communicate with portal server 330 and may have different capabilities and features. For example, they may have different display, processing or memory capabilities, they may use different markup languages, or they may have other distinguishable capabilities and features. Client device 310 is exemplified as a wireless client device that communicates with portal server 330 using a markup language such as WML, and client device 320 is exemplified as a PC that communicates with portal server 330 using HTML. It is appreciated that the features of the present invention are not limited to the example illustrated by FIG. 3.

FIG. 4 is a flowchart 400 of one embodiment of a process for storing device profiles according to an embodiment of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 can be performed in an order different than presented, and that not all of the steps in flowchart 400 may be performed. In one embodiment, the method of flowchart 400 is implemented by computer systems such as computer system 112 of FIG. 1. In one such embodiment, the method of flowchart 400 is implemented by portal server 330 and directory server 340 of FIG. 3.

The respective roles of portal server 330 and directory server 340 in the performance of the method of flowchart 400 are described further below. In general, portal server 330 manages the method of flowchart 400 while directory server 340 performs the method. However, as mentioned above, the functionality of the portal server 330 and the directory server 340, at least in regard to the method of flowchart 400, can be performed on a single server instead of on multiple servers.

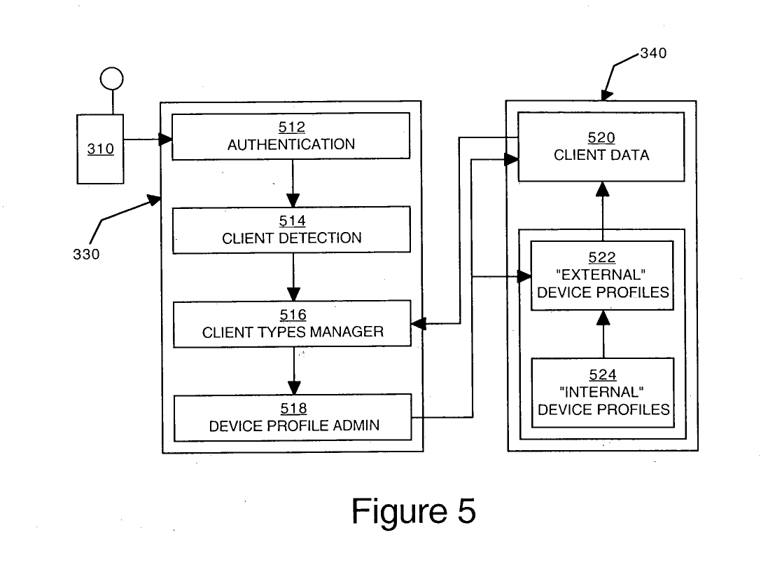

In one embodiment, with reference to FIG. 3 and to step 410 of FIG. 4, information that identifies the different properties of each of a plurality of different wireless client devices is accessed by directory server 340. At this point in flowchart 400, the information is embodied as an Extensible Markup Language (XML) file for each of the wireless client devices. Typically, this information is not received from the wireless client devices themselves, although the client devices are not precluded from providing it. Instead, this information is typically received from a centralized source of such information. What is of significance is not necessarily the source of the property information but that this information, in XML form, is resident on directory server 340. In one embodiment, the property information resides as “external” device profiles and “internal” devices profiles in directory server 340 (blocks 522 and 524 of FIG. 5, respectively).

For the purposes of the discussion herein, a distinction is made between “properties” and “characteristics.” As used herein, a characteristic describes a particular category of properties while properties are instances of a characteristic. Thus, for example, characteristics can include a category called “hardware”and a category called “software,” while screen size is an example of a hardware property and type of operating system is an example of a software property. In XML form, the characteristics and properties of a device are represented in a hierarchy or tree-like structure. That is, the wireless device is identified by its brand name and model number, for example, at the highest level of the hierarchy. The characteristics of the device are at the next level of the hierarchy, and the properties are at the next level of the hierarchy after the characteristics level. There may of course be more levels of the hierarchy than described by the preceding example.

In step 420 of FIG. 4, a node is created for each of the wireless client devices identified by the information received in step 410.

In step 430, the properties of the wireless client devices are stored as attributes of a respective node. That is, the properties of a particular wireless client device are stored as attributes of the node associated with that device.

In the present embodiment, steps 420 and 430 of FIG. 4 are implemented according to a schema that is defined so that the property information can be stored on a device-by-device basis in a software directory. In one embodiment, the directory is a Lightweight Directory Access Protocol (LDAP) directory (or database) and the schema is an LDAP schema. In such an embodiment, in order to use portal server 330 (FIG. 3) to manage the schema, LDAP subschema elements are used to create a Directory Information Tree (DIT) for each wireless client device.

LDAP directories, schema, subschema and DITs are terms known in the art. As an overview, an LDAP directory or database includes a number of individual nodes (e.g., records, objects or entries). Each node has a number of attributes, which are name-value pairs. An attribute can be multi-valued. A schema specifies rules for the directory, such as the types of nodes that can be included in the directory, and the types of attributes for each node. A DIT provides a naming hierarchy for naming the nodes in an LDAP directory. A subschema can be used to provide a different schema for a particular branch of the DIT.

A subschema defined according to the embodiments of the present invention makes each client device a node in the directory, with the device's properties as the attributes of the node. The subschemas so defined provide the flexibility to group a set of properties for each client device without having to use XML.

A subschema is defined for each client device and that device's properties are stored as an instance of that subschema. These properties include properties that are common to all clients, such as screen size, memory capacity, or keyboard capability. These properties can also include properties that are application-defined or that are specific to a particular client device.

Table 1 below provides an exemplary subschema definition according to an embodiment of the present invention.

TABLE 1
Exemplary Subschema Definition

<ServicesConfiguration>

<Service name=“PortalClientDataInternal version=”1.0”>
<Schema

i18nFileName=“PortalClientData”
i18nKey=“PortalClientDataDescription”
serviceHierarchy=“/ClientCapability/PortalClientData”>

<Global>

<!--store the profilemanager.xml-->
<AttributeSchemaName=“profileManagerXML” type=“single” syntax=“xml”/>
<SubSchema name=“clientData”><!--This represents the name of the client-->

<AttributeSchema name=“contentType” type=“single” syntax=“boolean”/>
<AttributeSchema name=“parentID” type=“single” syntax=“string”/>
<AttributeSchema name=“clientType” type=“single” syntax=“string”/>
<AttributeSchema name=“WmlDeckSize” type=“single” syntax=“number”/>
<AttributeSchema name=“TablesCapable” type=“single” syntax=“boolean”/>
<AttributeSchema name=“CcppAccept-Charset” type=“single” syntax=“string”/>

<!--add all the other common properties-->

<!--additional properties-->

<AttributeSchema name=“additionalProperties” i18nKey=“additionalProperties”

any=“display” type=“list” syntax=“string”/>

</SubSchema>

</Global>

</Schema>

</ServicesConfiguration>

In Table 1, “profilemanagerXML” refers to an attribute that is defined to store client detection lookup rules for matching the HyperText Transfer Protocol (HTTP) header of a client device, as described further in conjunction with FIG. 5 below. The example schema of Table 1 includes the properties “contentType,” “parentlD,” “clientType,” “WmlDeckSize,” “TablesCapable,” and “CcppAccept-Charset.” Additional properties can also be included, as exemplified by Table 2.

Table 2 below provides an exemplary instance of the subschema of Table 1, referred to as a “SubConfiguration,” according to an embodiment of the present invention.

TABLE 2
Exemplary Configuration

<Configuration>

<GlobalConfiguration>
<SubConfiguration name=“BrandName&ModelNumber”
id=“clientData”>

<Attribute ValuePair>

<AttributeName=“contentType”/>
<Value>text/vnd.wap.wml</Value>

</AttributeValuePair>
<AttributeValuePair>

<AttributeName=“parentID”/>
<Value>WML</Value>

</AttributeValuePair>
<AttributeValuePair>

<AttributeName=“clientType”/>
<Value>BrandName&ModelNumber</Value>

</AttributeValuePair>
<AttributeValuePair>

<AttributeName=“WmlDeckSize”/>
<Value>4096</Value>

</AttributeValuePair>
<AttributeValuePair>

<AttributeName=“tablesCapable”/>
<Value>false</Value>

</AttributeValuePair>
<AttributeValuePair>

<AttributeName=“ccppAccept-Charset”/>
<Value>UTF-8</Value>

</AttributeValuePair>
<!--additional properties--><!--multi-values
separated by a comma “,”-->
<Attribute ValuePair>

<AttributeName=“additionalProperties”/>

<Value>DeviceType=phone</Value>
<Value>Geography=Europe</Value>
<Value>NumberOfColors=2</Value>
<Value>SupportedImages=GIG,BMP,JPEG</Value>

</AttributeValuePair>

</Subconfiguration>

</Configuration>

In Table 2, values for the properties identified in Table 1 are provided, and additional properties for “DeviceType,” “Geography,” “NumberOfColors,” and “Supportedimages” are included with their values.

Continuing with reference to FIG. 4, in step 440, in order to read a device property, the corresponding attribute of the appropriate node is fetched. Significantly, the attribute is read without parsing and validation of the property information.

In step 450, in order to modify a device property, the new value of the property is written to the corresponding attribute of the appropriate node. Again, this is accomplished without parsing and validating the property information.

In one embodiment, a user-friendly interface is introduced for management of the information for the wireless client devices. In one such embodiment, the user interface includes a client manager user interface and a client editor user interface. The client manager user interface functions to list the client devices, and the client editor user interface functions to manage the properties of the client devices.

In one embodiment, client profiles are categorized either as a base profile, a style profile, or a device profile. Base profiles include the default properties for each of the particular types of markup languages (e.g., WML, cHTML, HDML, HTML, iHTML, XHTML, JHTML and VoiceXML). Style profiles contain properties that define a style for a subset of devices within a particular type of markup. For example, a style can be identified for all devices having the same brand name (e.g., Nokia); for example, the Nokia style is applied to all devices manufactured by Nokia. Device profiles are specific to a device brand name and model number.

In the present embodiment, the client manager user interface groups clients by style. A style is selected from a pull down menu. When a style is selected, all of the devices of that style are displayed. Filters can be applied to filter the list.

New devices can be added, and existing devices can be edited. The client editor user interface is used to create and customize device profiles. The client editor user interface lists device properties grouped by classification. A classification can be selected using a pull down menu. Required properties are indicated as such. Each property is listed by name followed by a user interface component that depends on the property syntax. For example, for a string syntax, a text field is displayed, and for a boolean syntax, a check box is displayed. Additional properties not defined by the schema can also be input.

FIG. 5 is a block diagram showing data flow through a portal server 330 and a directory server 340 according to an embodiment of the present invention. In this embodiment, the portal server 330 includes an authentication block 512, a client detection block 514, a client types manager block 516, and a device profile administrator block 518, while the directory server 340 includes a client data block 520, an “external” device profiles block 522, and an “internal” device profiles block 524. It is appreciated that the portal server 330 and the directory server 340 can include functional blocks other than those shown and described. Furthermore, in another embodiment, the functionality about to be described for portal server 330 and directory server 340 can be allocated differently between those or other servers, or the functionality can be performed by a single server.

The authentication block 512 can be associated with the mobile portal block 210 of FIG. 2. The authentication block 512 performs authentication of the wireless client device 310 and/or its user using a selected authentication module.

The client detection block 514, the client types manager block 516, and the device profile administrator block 518 of FIG. 5 can be associated with the mobile rendering block 224 of FIG. 2. The client detection block 514 presents the user interface for the selected authentication module. The client detection block 514 uses a client detection application programming interface (API) to determine the device-specific properties of wireless client device 310 via the client types manager block 516, by querying the HTTP header from a client's request. The device profile administrator block 518 manages the device profile data on directory server 340 using APIs on portal server 330 for accessing and modifying device profiles.

In the present embodiment, there are three sources of device profiles that are referred to herein as the client data block 520, the “external” device profiles block 522, and the “internal” device profiles block 524. The client data block 520 includes device profiles stored as nodes with device properties as attributes of those nodes, as described previously herein. The internal device profiles block 524 includes data in XML form that cannot be modified (e.g., read only). The external device profiles block 522 includes data in XML form that overrides data in the internal device profiles block 522.

The information in the external and internal device profiles blocks 522 and 524 is processed according to the schema described in conjunction with FIG. 4. The information in these blocks can be pre-processed according to the schema discussed herein to generate device profiles that can be placed in client data block 520. Alternatively, the schema can be applied to the external and internal device profiles blocks 522 and 524 on demand (that is, when needed) to generate device profiles that can be placed in client data block 520.

In the present embodiment, client types manager block 516 picks up data for a client device from the three data sources according to the following order: client data block 520, followed by external device profiles block 522, followed by internal device profiles 524. Thus, if a device profile exists in client data block 520 for a client device of interest, it will be read first. If not, then the device properties for the client device of interest are retrieved from external device profiles block 522 and processed according to the schema discussed herein. If there are no such device properties in external device profiles block 522, then the device properties for the client device of interest are retrieved from internal device profiles block 524 and processed according to the schema discussed herein.

In summary, according to the embodiments of the present invention, information that identifies properties of each of a plurality of wireless client devices is initially in XML form. A node in a software directory is created for each of the wireless client devices. The properties of each wireless client device are stored as attributes of a respective node in the software directory, in other than an XML form.

By storing device profiles in this manner, the reading of a device property reduces to fetching an attribute of the appropriate node, and the writing of a device property reduces to modifying an attribute of the appropriate node. Parsing and validation of device profiles can be eliminated, improving performance. Moreover, the profiles can be managed by a user-friendly interface.

Accordingly, embodiments of the present invention allow device-dependent characteristics and properties to be readily stored and retrieved on a server such as a portal server or on a directory server in communication with a portal server. As a result, the portal server can quickly and efficiently provide services and other types of support for a wide variety of client devices having different properties.

Embodiments of the present invention, extensible customizable structured and managed client data storage, have been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of storing client device profiles on a server, said method comprising:
accessing information that identifies properties of a wireless client device, wherein said information is received in Extensible Markup Language (XML) form;
creating a node for said wireless client device in a software directory resident on said server; and
storing said information identifying properties of said wireless client device as attributes of said node in said software directory, wherein said information for said wireless client device is stored in other than said XML form.

2. The method of claim 1 wherein said server is a portal server.

3. The method of claim 1 wherein said server is a directory server coupled to a portal server.

4. The method of claim 1 wherein said software directory comprises a Lightweight Directory Access Protocol (LDAP) directory comprising a node for each of a plurality of wireless client devices, wherein an LDAP Directory Information Tree (DIT) is created for each of said wireless client devices.

5. The method of claim 1 further comprising parsing said information received in said XML form prior to said creating and storing.

6. The method of claim 1 further comprising fetching an attribute from said software directory.

7. The method of claim 1 further comprising modifying an attribute in said software directory.

8. A computer system comprising:
a memory unit; and
a processor coupled to said memory unit, said processor for executing a method of storing client device profiles, said method comprising:
accessing information that identifies properties of a wireless client device, wherein said information is received in Extensible Markup Language (XML) form;
creating a node for said wireless client device in a software directory; and
storing said information identifying properties of said wireless client device as attributes of said node in said software directory, wherein said information for said wireless client device is stored in other than said XML form.

9. The computer system of claim 8 wherein said computer system is a portal server.

10. The computer system of claim 8 wherein said computer system is a directory server coupled to a portal server.

11. The computer system of claim 8 wherein said software directory comprises a Lightweight Directory Access Protocol (LDAP) directory comprising a node for each of a plurality of wireless client devices, wherein an LDAP Directory Information Tree (DIT) is created for each of said wireless client devices.

12. The computer system of claim 8 wherein said method further comprises parsing said information received in said XML form prior to said creating and storing.

13. The computer system of claim 8 wherein said method further comprises fetching an attribute from said software directory.

14. The computer system of claim 8 wherein said method further comprises modifying an attribute in said software directory.

15. A computer-usable medium having computer-readable program code embodied therein for causing a computer system to perform a method of storing client device profiles, said method comprising:
receiving information that identifies properties of a wireless client device, wherein said information is received in Extensible Markup Language (XML) form;
creating a node for said wireless client device in a software directory; and
storing said information identifying properties of said wireless client device as attributes of said node in said software directory, wherein said information for said wireless client device is stored in other than said XML form.

16. The computer-usable medium of claim 15 wherein said computer system is a portal server.

17. The computer-usable medium of claim 15 wherein said computer system is a directory server coupled to a portal server.

18. The computer-usable medium of claim 15 wherein said software directory comprises a Lightweight Directory Access Protocol (LDAP) directory comprising a node for each of a plurality of wireless client devices, wherein an LDAP Directory Information Tree (DIT) is created for each of said wireless client devices.

19. The computer-usable medium of claim 15 wherein said computer-readable program code embodied therein causes said computer system to perform said method further comprising parsing said information received in said XML form prior to said creating and storing.

20. The computer-usable medium of claim 15 wherein said computer-readable program code embodied therein causes said computer system to perform said method further comprising fetching an attribute from said software directory.

21. The computer-usable medium of claim 15 wherein said computer-readable program code embodied therein causes said computer system to perform said method further comprising modifying an attribute in said software directory.

22. The computer-usable medium of claim 15 wherein said information is received from a data base resident on said computer system.

23. The computer-usable medium of claim 15 wherein said information is received from another device in communication with said computer system.
